(19) United States
(12) Patent Application Publication
(10) Pub. No.: US 2020/0298944 A1
(43) Pub. Date: Sep. 24, 2020

(54) Method for Installing a Subsea Structure

(71) Applicant: SLLP 134 Limited, Aberdeen (GB)

(72) Inventor: Malcolm Bowie, Peterculter, Aberdeen (GB)

(73) Assignee: SLLP 134 Limited, Aberdeen (GB)

(21) Appl. No.: 16/088,467

(22) PCT Filed: Mar. 29, 2017
(86) PCT No.: PCT/GB2017/050876

§ 371 Date: Sep. 26, 2018

(30) Foreign Application Priority Data
Mar. 29, 2016 (GB) 1605235.9

(51) Int. Cl. B63B 77/00; E02B 17/02; E02D 29/09; B65D 88/78; F17C 13/08; B65D 90/20

(52) U.S. Cl. CPC B63B 77/00; E02B 17/02; E02D 29/06; E21B 41/0007; F17C 13/082; B65D 90/20; B65D 88/78

(57) ABSTRACT

A method for installing a subsea structure at a target installation site in an underwater location is disclosed. The method includes connecting at least one mooring line and at least one leading line to the structure, and towing the structure via the leading line from a deployment position to the target installation site, such that the structure moves both vertically and horizontally between the deployment position and the target installation site. The mooring line is anchored, e.g. to an anchoring device on the seabed, and can incorporate a ballast to apply a sinking force to the structure in proportion to the length of unsupported line. The mooring line and the leading line can together stabilise the structure as it descends to the installation site. The non-vertical installation allows accurate structure placement, e.g. in crowded fields, with less sensitivity to tidal or current forces.

This invention relates to a method for installing a subsea structure such as a storage tank at a target installation site in an underwater location, and particularly installation of the structure at a target site on the seabed or on another subsea surface, but the method can equally be applied to any structure installed or removed from a underwater location.

The installation of structures subsea often requires accurate positioning of the structure in a particular location, for example, on a target site on the seabed adjacent to one or more items of subsea infrastructure associated with an oil or gas field.

Most structures are deployed using a crane mounted on a surface vessel, and are lowered from the vessel located directly above the target site. An alternative approach is to tow the structure to the target site and sink it into position.

### SUMMARY

According to the invention there is provided a method for installing a subsea structure at a target installation site in an underwater location, the method comprising connecting at least one mooring line to the structure, connecting at least one leading line to the structure, and towing the structure via the leading line from a deployment position spaced laterally away from a target installation site to an installation position above the target installation site, and moving the structure both vertically and horizontally through the water between the deployment and installation positions.

Moving the structure both vertically and horizontally in the manner described allows easier and quicker subsea installation operations with less demanding vessels.

Optionally the at least one mooring line is anchored, e.g. to the seabed or another subsea structure, and resists lateral movement of the anchored end of the mooring line. The mooring line is optionally flexible, and optionally incorporates a ballast weight or similar, so that the line exerts a sinking force on the structure in proportion to the amount of mooring line that is unsupported between the seabed and the structure. The mooring line can optionally comprise a chain, or optionally a combination of chain and wire.

Optionally the structure is buoyant at the deployment position, and can optionally be floating on the surface of the water. Optionally the structure can incorporate an adjustable ballast feature, which allows the buoyancy of the structure to be varied. The buoyancy is optionally decreased when the structure is located in the deployment position, so that the structure becomes less buoyant and sinks through the water, optionally while the stability of the structure in the water is controlled by tension in the mooring line and the leading line. Thus the structure descends in a controlled manner while moving laterally in a horizontal plane with respect to the target installation site, until it is located directly above the target installation site on the seabed.

Optionally, in some phases of movement of the structure between the deployment position and the installation position the horizontal displacement and the vertical displacement can be substantially equal, producing movement along a substantially linear path. Optionally in some phases of the movement, the horizontal and vertical displacement can be different relative to each other, for example, producing movement along a substantially non-linear or curved path. For example, during initial movement away from the deployment position through the water column, the horizontal displacement can be greater than the vertical displacement, leading to movement along a generally convex curved path away from the deployment position. The generally convex curved path may optionally transition into a more substantially linear movement as the combined effects of ballast and buoyancy equalise the vertical and horizontal displacements.

This non-vertical installation method also allows more accurate placement, especially in crowded fields. Further, there is less sensitivity of the method as described to uncontrolled lateral movements of the structure away from the target, for example, resulting from tidal or current forces in the water. This method also removes the requirement for personnel to board the structure being towed to attach lifting sling to a crane, since the towing lines are connected to the pre-installed mooring line on the deck of the towing vessels in a safe and controlled manner, familiar to the normal operating procedure of the personnel on board.

Optionally the leading line tows the structure in a lateral direction away from the at least one anchored mooring line and towards the target installation site, applying a force in an opposite direction to the mooring lines. Optionally the structure descends in an arcuate path through the water.

Optionally the structure can be towed by the leading line into the deployment position.

Optionally, the leading line is flexible and optionally ballasted, and optionally adopts a catenary configuration between the structure and a towing vessel, to which the leading line can optionally be connected. The leading line can optionally comprise a chain. As the towing vessel tows the structure laterally towards the target installation site, the catenary configuration of the leading line is optionally adjusted in order to provide sufficient ballast to the structure. This can help to maintain the structure on a generally stable horizontal plane. In other words, as the leading line is tensioned, resulting from the movement of the tow vessel away from the deployment position, and optionally away from the structure, the leading line is optionally gradually paid out from the tow vessel, in order to control the catenary configuration of the leading line, and hence exert the correct amount of weight on the structure from the ballast in the leading line. Optionally the catenary configuration of the leading line is adjusted during descent of the structure to balance the structure during the descent, for example by deploying more chain to pull the structure down, or retracting the chain to raise the structure. Similarly, this action can also be used to adjust the trim (angle of the structure in the horizontal plane) as required. As the structure is lowered through the water column, further ballast may be added in a controlled manner to lower the structure. The catenary of the mooring lines controls the vertical position of the structure by reducing downward force as more ballast is added.

Optionally, the leading line and mooring line are connected to the structure at spaced apart locations, and optionally at symmetrically opposite locations. For example, in the case of a structure that is generally cylindrical, the mooring and leading lines could optionally be connected to the structure at diametrically opposite locations, so that downward force exerted by the leading and mooring lines would be applied to diagonally opposite locations of the generally cylindrical structure, thereby balancing the force and enhancing the stability of the structure.

In some examples, more than one mooring line can be attached to the structure. In such options, the mooring lines can be attached at spaced apart locations on one side of the structure, whereas the leading line can be connected at an opposite side of the structure to the mooring lines, typically opposite to a bisector between the two mooring lines. Optionally, the two mooring lines can incorporate an angular deviation between them, and hence can extend away from the structure at different angles. With two or more mooring line, the structure can be towed in an opposite direction to the bisector of the outermost mooring lines.

In some examples, at least two mooring lines are provided, and are attached at connection points on the structure that are angularly spaced around the structure. This can control positioning in different horizontal directions and can improve control of the heading and position during the descent and landing operation. Optionally the angular spacing between the two mooring lines and between at least one of the mooring lines and the leading line is approximately equal, for example, with two mooring lines and one leading line the angular spacing between adjacent lines can be approximately 120 degrees, but in other examples, different angular spacing can be adopted.

In certain examples, two mooring lines can be laid on the seabed converging at approximately 120 degrees towards the target installation site of the structure on the seabed. The mooring lines can be fixed at their far ends by anchoring devices and their near ends can optionally terminate at a length sufficient to reach the deployment position which is spaced away from the target installation site in both horizontal and vertical directions. The length of the mooring lines between the anchors and the structure is optionally the same (for example within 5-10%, or within 2-5%) as the horizontal displacement between the anchors and the target installation site, and particularly between the anchors and the connection point on the structure when in position on the target installation site, so that during descent, the structure is constrained to move in a vertical and horizontal path that terminates at or near the target installation site on the seabed, and optionally immediately above the target site. The angle between the mooring lines is subject to determination of the optimum angle given the conditions at site and any obstacles in way of their route on the seabed, and different values can be adopted in different examples.

Optionally more than one tow line is provided, and in such cases the tow lines can be spaced apart on the structure with an angular separation in the same manner as is described above for the mooring lines. Optionally the angular separation of the leading and/or mooring lines need not be identical but it is optionally regular, and optionally symmetrical, which helps to stabilise forces acting on the structure during the movement from the deployment position to the target installation site, and reduces at least one of pitch, yaw and roll of the structure during such movement.

Optionally the positioning of the leading and/or mooring lines is selected such that the vector sum of the forces applied to the structure by the or each leading line is resolved in the diametrically opposite direction to the vector sum of the forces applied to the structure by the or each mooring line. Optionally, providing this condition is met, any number of leading and mooring lines can be connected to the structure.

Optionally the structure can be urged (e.g. towed) in one horizontal direction towards the target site by the leading line, and the horizontal movement of the structure towards the target site can optionally be controlled by at least one second tow line applying a force in the opposite direction for at least some of the time during the movement of the structure. Thus two or more tow vessels can optionally be used for the installation operation and can optionally be connected to the structure at different locations, e.g. at opposite ends of the structure. Each tow line can optionally be attached to a respective tow vessel. In one example, a leading tow line is attached to the forward end of the structure closest to the target installation site, and at least one other (trailing) tow line can be attached towards either the rear of the structure (further away from the target installation site) and optionally can be attached to the connection points which connect to the mooring lines.

A trailing vessel can recover the end of each pre-laid mooring line from the seabed whilst still connected to the structure via a trailing tow line and can connect the mooring line either directly to the structure, or more commonly can connect the two components indirectly with a mooring line connector shackle, optionally having a set length measured such that the distance between the anchored end of the or each mooring line on the sea bed and the structure is the same as the horizontal distance along the seabed between the anchored end of the or each mooring line on the seabed and the structure (optionally the connection point on the structure) when in position on the target installation site, so that the structure will be constrained to move horizontally and vertically towards the target installation site on the seabed, being constrained to land just above the target installation site. This measured length may be part of the towing arrangement or connected to the towing arrangement such that the end of the measured length may be recovered safely onto the towing vessel for connection to the end of the pre-laid mooring(s). Alternatively a separate support vessel such as an ROV (remotely operated vehicle) may recover the end of the pre-laid mooring lines and pass this across to the trailing vessel(s).

Once both of the (optionally pre-installed) mooring lines are connected to the structure the trailing vessel(s) can commence paying out of their towing winches to allow the disconnection of the vessels from the structure being towed. During this time the lead vessel can move forward adjusting position as necessary to ensure tension is maintained on its tow line and the pre-installed mooring lines, thus controlling the heading, drift and orientation of the structure.

Once the trailing vessel(s) are disconnected and position of the structure/lead vessel stabilised the lowering of the structure may commence. The lowering operation may include a number of different methods to reduce the buoyancy of the structure, for example, gas-filled compartments of the structure could be flooded, fluids in the structure can be replaced by denser fluids, and/or weights can be added to the structure etc. Once the structure is neutrally buoyant and commences sinking the tension in the mooring lines can reduce slightly and at this stage, the lowering operation can be controlled by the lead vessel adjusting the applied force and length of the towing line. During the lowering operation the lead vessel optionally applies tension sufficient to keep the structure moving horizontally during the descent, so that the mooring lines are under tension, and optionally under balanced tension where more than one line is provided. That is, optionally the horizontal component of movement can be controlled by force applied to the subsea structure by the lead tow line or lines, optionally where the force applied by the lead tow line or lines acts to maintain tension in the mooring line or lines, and urge the subsea structure in a horizontal direction away from the mooring lines and towards the target installation site. The vertical component of movement of the structure is optionally controlled by the quantity of ballast applied to the structure, for example, the ballast effect of the mooring and leading lines not yet laid on the seabed and suspended between the seabed and the structure, and the ballast on or in the structure, and optionally by the tension in the lines connected to the structure. The forces acting on the structure in a vertical direction (ballast, buoyancy, tension etc.) are optionally adapted to resist rapid and uncontrolled movement of the structure. Prior to landing the structure on the seabed in the target installation site, the position, heading and depth may be checked by transponder devices optionally fitted to the structure, or by ROV etc. Once the structure is directly above the target installation site, optionally within 10 m of vertical separation between the two, the final lowering step can be performed using a combination of adjustment of ballast and buoyancy on the structure system and lead vessel tow-line tension.

Once in position in the target installation site on the seabed the lead vessel optionally pays out the towing line which will act as a third mooring line. An anchoring device is optionally connected to the end of this third mooring line prior to deployment to the seabed. The mooring line will be laid under tension to minimum slack. At this stage the structure is anchored to the seabed by the two mooring lines initially laid before the descent, and by the leading line now acting as a third mooring line; all mooring lines are optionally symmetrically and optionally regularly spaced around the structure, for example, in this case, with three mooring lines, the circumferential angular spacing between them is 120 degrees, but with four lines the spacing could be different (e.g. 90 degrees).

The anchored structure may then be de-ballasted to lift it from the seabed by a short distance, with the mooring lines restricting floating of the structure to the surface, by virtue of the tension in the lines. This lifting operation could typically be conducted to allow inspection underneath the structure or facilitate connection to a floating structure which may be tethered to the subsea structure.

The method may be performed with a single mooring line and a single tow line with headings substantially opposite to one another, but a second (trailing) mooring line is beneficial as it is then easier to control the pitch, yaw and roll of the subsea structure during the installation.

Where a floating structure is to be tethered to the structure the following method may be used to control the horizontal position and depth of the floating structure, during the operation of connecting the tethers between the subsea structure and the floating structure.

Following landing of the subsea structure on the sea bed, a floating structure such as a buoy may be secured in position above it, optionally using the same method. Optionally at least one, optionally two pre-installed mooring lines are connected to the buoy by a trailing vessel. The floating structure mooring lines are connected to the floating structure well above the seabed, so the horizontal position of the floating structure will be affected by the magnitude and direction of the prevailing current and other forces acting laterally upon it. Therefore the tension in each mooring line for the buoy is optionally determined in concert with the length of the mooring lines for the buoy to minimise the horizontal movement of the buoy after installation. Optionally the mooring lines connected at their upper ends to the floating structure are connected at their lower ends to the same anchors that anchor the mooring lines for the subsea structure. Optionally the length of each of the mooring lines for the buoy is approximately 150-200% of the water depth at the installation site. Optionally the mooring lines connected at their upper ends to the floating structure are connected at their lower ends to the mooring lines for the subsea structure, for example, to a point between the anchor and the structure on the mooring lines for the structure. The mooring lines for each of the floating and subsea structures are optionally the same length.

Once both of the trailing mooring lines are connected to the floating structure the trailing vessel(s) can commence paying out of towing winches to allow the disconnection of the vessels from the floating structure being towed. During this time the lead vessel can move forward adjusting position as necessary to ensure tension is maintained on its tow line and on the trailing mooring lines, thus controlling the heading and drift of the buoy. Once the trailing vessel(s) are disconnected the lead vessel can pay out the towing line as previously described which can subsequently act as a third mooring line as described above. The lead vessel can adjust its position until the floating structure is positioned above the subsea structure or in its target horizontal location. The lead vessel can then pay out the towing line/mooring line adjusting the position of the vessel as required to ensure the floating structure is kept above the target location. As the tow line is paid out and sinks, more tow line will rest on the seabed so the floating structure position will become more stable. An anchoring device can be connected to the end of the tow line prior to deployment to the seabed as the third mooring line, optionally being laid under tension to minimise slack and ensure the buoy is maintained in the target position. Optionally the third anchor for the buoy is laid in the same location as the anchor for the third mooring line for the subsea structure, and optionally the same anchor can be used.

Alternatively separate anchors can be pre-installed (one for each mooring line including the final tow line) before movement of the subsea structure, and each anchor can optionally have respective pre-installed mooring lines for the floating structure and for the subsea structure in the form of ‘tails’ for each of the subsea and floating structures connected to the anchors. These could be installed as part of the pre-installed mooring lines for the subsea structure. This would simplify the installation of the pre-installed mooring by having one anchoring device per heading.

During the connection of the floating structure to the subsea structure the mooring lines can be used to control the position and depth of the various elements in a number of different ways. One way is to de-ballast the subsea structure to clear the seabed, with the travel of the subsea structure off the seabed being constrained by the mooring lines attached to the subsea structure; tension would increase in the mooring lines as the structure rises higher above the seabed, thereby limiting the travel. Tethers can then be connected between the floating structure and the subsea structure as the two structures approach and the distance between them reduces. The mooring system also controls the heading and relative position of the subsea and the floating structure. The subsea structure can then be re-ballasted to sink back down onto the seabed, to pull the buoy down to a working depth, after the tethers have been secured. Tethers can optionally be transported to the installation site on the top of the tank assembly.

Alternatively the subsea structure can remain on the sea bed and the floating structure can be pulled down towards it by attachment of ballast weight to pre-defined locations on the mooring lines connected to the floating structure. This increases the draught of the floating structure thus allowing connection of the tethers between the subsea and floating structures. The additional ballast can be released after connection of the tethers to float the buoy to the working position. The mooring lines for the buoy may also be performed at the end of the connection operation, subject to the requirements of the system design. The removal of the floating structure or replacement of the tethers may be performed using the same steps to either increase the draught of the buoy or to increase the buoyancy of the subsea structure to reduce the distance between the subsea and floating structures.

This method is particularly advantageous whereby a subsea structure is to be re-floated some time after installation, for example, at the end of its useful life or at a service interval. In such cases, there can be significant uncertainty about the buoyant factors acting on the subsea structure, for example, weight of marine growth, contents of the structure, material loss due to corrosion and suction effects of soils. The mooring system allows additional control of the ascent of the structure thereby mitigating rapid and uncontrolled breakout of the structure from the seabed and uncontrolled ascent of the subsea structure.

The subsea structure can be permanently anchored by any one or more of the mooring lines, piles, additional of further ballast and suction cans provided on or acting on the structure.

Optionally piles may be transported along with the structure during towing either vertically within their guides or horizontally atop or at the side of the structure. This eliminates the need for separate pile transportation offshore on a separate vessel.

According to another aspect of the invention the subsea structure can be used as a base or an anchoring point for various items of subsea equipment such as flow lines and manifolds.

Thus according to a further aspect, the invention provides a subsea storage tank assembly having at least one storage compartment for storage of production fluids produced from an offshore subsea oil or gas well, the subsea storage tank assembly comprising at least one item of subsea equipment supported on the storage tank assembly. The subsea equipment optionally comprises a valve, a manifold, a subsea isolation valve, a support for a fluid flowline, a support for a riser etc., and may optionally have a structural support frame adapted to resist movement of the subsea equipment relative to the storage tank assembly. The subsea equipment may be at least partially covered by a protective cover mounted on the storage tank assembly.

The invention also provides a base for subsea equipment comprising a subsea storage tank assembly having at least one storage tank for storage of production fluids produced from an offshore subsea oil or gas well.

The invention also provides a method of deploying an item of subsea equipment comprising supporting the subsea equipment on a subsea storage tank assembly having at least one storage tank for storage of production fluids produced from an offshore subsea oil or gas well.

The subsea storage tank assembly can optionally comprise a ballast compartment.

In one example, the subsea structure is used as a base and/or anchor for a fluid flow line such as a riser, which can be connected between a subsea flow line and the floating structure, optionally once the floating structure has been tethered to the subsea structure, and can form a fluid flow path for exporting production fluids from subsea wells to the floating structure. Optionally the riser is flexible, and the subsea structure can optionally support and/or anchor a mid-water arch for the riser. Using the subsea structure as a base or anchoring point for additional subsea field architecture mitigates the need for additional anchors and bases to be deployed in the field.

Optionally the subsea structure comprises a riser support structure. Optionally the riser support structure is in the form of a fixed or optionally a lazy “S” riser support arch. Optionally the riser support arch is adapted to support a dynamic flexible riser. Optionally the dynamic flexible riser is connected by a valve connection to a rigid spool. Optionally the valve is disposed on the roof of the subsea structure, optionally on a flattened portion when the roof is domed. Optionally the rigid spool connects to at least one hydrocarbon export pipeline exporting production fluids from wellheads or other sources on the seabed. Optionally the rigid spool is formed with at least one 90 degree bend, optionally two or more 90 degree bends.

Optionally the subsea equipment based on or anchored to the structure can be protected from damage by, for example, dropped debris by a protection structure arranged on the structure and optionally adapted to encase or house the equipment, for example, valves spools and optionally other components such as manifolds connecting other pipes to the riser. Optionally the protection structure is formed from plastic, metal, or another rigid material.

Optionally the riser is a free-hanging dynamic flexible riser. Optionally the subsea structure provides the base anchoring a dynamic riser support structure, optionally sited on the roof of the subsea structure.

Optionally the flexible riser connects to a rigid spool, optionally with the point of connection being located within the dynamic riser support structure. Optionally the rigid spool forms a u-bend within the dynamic riser support structure. Optionally the rigid spool comprises at least one, optionally more than one, 90-degree bend.

Optionally the rigid spool connects to a second rigid spool optionally via a valve connection. Optionally, the valve connection and optionally at least part of the rigid spool is rested on or affixed to the roof of the subsea structure, optionally on a flattened portion where the roof is generally domed.

Optionally at least part of the first and optionally second rigid spools and optionally the valve are protected by the protection structure. Optionally at least a portion of at least one rigid spool is located within the subsea structure, optionally with an external valve connecting the rigid spool optionally with a flexible riser, optionally with a further rigid spool. Optionally, the valve is protected by the protection structure.

Optionally a manifold device for facilitating connection between at least two fluid flow lines and the riser can be disposed in or on the subsea structure. Optionally the manifold connection is located externally to the subsea structure, optionally on the roof of the subsea structure. Optionally more than one pipeline is routed to the subsea structure, and connects to the manifold to deliver production fluids to the riser via the manifold, optionally via a rigid spool, optionally via a valve connection. The manifold is optionally also protected by the protection structure.

The various aspects of the present invention can be practiced alone or in combination with one or more of the other aspects, as will be appreciated by those skilled in the relevant arts. The various aspects of the invention can optionally be provided in combination with one or more of the optional features of the other aspects of the invention. Also, optional features described in relation to one aspect can typically be combined alone or together with other features in different aspects of the invention. Any subject matter described in this specification can be combined with any other subject matter in the specification to form a novel combination.

Various aspects of the invention will now be described in detail with reference to the accompanying figures. Still other aspects, features, and advantages of the present invention are readily apparent from the entire description thereof, including the figures, which illustrates a number of exemplary aspects and implementations. The invention is also capable of other and different examples and aspects, and its several details can be modified in various respects, all without departing from the spirit and scope of the present invention. Accordingly, each example herein should be understood to have broad application, and is meant to illustrate one possible way of carrying out the invention, without intending to suggest that the scope of this disclosure, including the claims, is limited to that example. Furthermore, the terminology and phraseology used herein is solely used for descriptive purposes and should not be construed as limiting in scope. Language such as “including”, “comprising”, “having”, “containing”, or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Thus, throughout the specification and claims unless the context requires otherwise, the word “comprise” or variations thereof such as “comprises” or “comprising” will be understood to imply the inclusion of a stated integer or group of integers but not the exclusion of any other integer or group of integers.

Any discussion of documents, acts, materials, devices, articles and the like is included in the specification solely for the purpose of providing a context for the present invention. It is not suggested or represented that any or all of these matters formed part of the prior art base or were common general knowledge in the field relevant to the present invention.

In this disclosure, whenever a composition, an element or a group of elements is preceded with the transitional phrase “comprising”, it is understood that we also contemplate the same composition, element or group of elements with transitional phrases “consisting essentially of”, “consisting”, “selected from the group of consisting of”, “including”, or “is” preceding the recitation of the composition, element or group of elements and vice versa. In this disclosure, the words “typically” or “optionally” are to be understood as being intended to indicate optional or non-essential features of the invention which are present in certain examples but which can be omitted in others without departing from the scope of the invention.

All numerical values in this disclosure are understood as being modified by “about”. All singular forms of elements, or any other components described herein are understood to include plural forms thereof and vice versa. References to directional and positional descriptions such as upper and lower and directions e.g. “up”, “down” etc. are to be interpreted by a skilled reader in the context of the examples described to refer to the orientation of features shown in the drawings, and are not to be interpreted as limiting the invention to the literal interpretation of the term, but instead should be as understood by the skilled addressee.

### BRIEF DESCRIPTION OF THE DRAWINGS

In the accompanying drawings:

FIG. 1a shows a plan view of a subsea structure in the form of a storage tank assembly;

FIG. 1b shows a side view of the storage tank assembly of FIG. 1a;

FIG. 2a shows a plan view of the storage tank assembly of FIGS. 1a and 1b at a deployment location prior to connection of the mooring lines;

FIG. 2b shows a side view of FIG. 2a;

FIG. 3 shows a plan view of installation of the tank assembly of FIGS. 1a and 1b on the seabed;

FIG. 4a shows a plan view of the storage tank assembly of FIGS. 1a and 1b with mooring lines connected, trailing vessel tow lines disconnected, an ROV deployment vessel connected to the storage tank, and a lead vessel beginning to move the storage tank assembly towards the installation site;

FIG. 4b shows a side view of FIG. 3a;

FIG. 5 shows a side view of the installation process from a deployment location to installation of the tank assembly on the seabed;

FIG. 6 shows the storage tank assembly of FIGS. 1a and 1b having been placed into position on a target installation site;

FIG. 7 shows a close-up side view of the pile structure;

FIG. 8a shows a plan view of the installed subsea tank with an offshore production buoy being towed towards an installation site;

FIG. 8b shows a side view of FIG. 8a;

FIG. 9a shows a plan view of the offshore production buoy connected to mooring lines;

FIG. 9b shows a side view of FIG. 9a;

FIG. 10a shows a plan view of the offshore production buoy being positioned for installation;

FIG. 10b shows a side view of FIG. 10a;

FIG. 11a shows a plan view of the offshore production buoy in place above the storage tank assembly, the storage tank assembly being de-ballasted by a ballast control vessel;

FIG. 11b shows a side view of 11a with the storage tank assembly being shown as de-ballasted and lifted clear of the seabed;

FIG. 12a shows a plan view of the offshore production buoy after installation and tethering to the storage tank assembly;

FIG. 12b shows a side view of FIG. 12a, with the offshore production buoy tethered to the storage tank assembly and connected by risers;

FIG. 13a shows a side view of the installed storage tank assembly anchoring a support arch adapted to support a flexible riser with the connecting conduits between the riser and the pipeline being external to the tank;

FIG. 13b shows a plan view of FIG. 13a;

FIG. 14a shows a side view of the installed storage tank assembly anchoring a support arch adapted to support a flexible riser with a portion of the connecting conduits between the riser and the pipeline passing through the inside of the tank;

FIG. 14b shows a plan view of FIG. 14a;

FIG. 15a shows a side view of the installed storage tank assembly anchoring a manifold and a support arch adapted to support a flexible riser;

FIG. 15b shows a plan view of FIG. 15a;

FIG. 16a shows a side view of the installed storage tank assembly anchoring a dynamic riser support structure adapted to support a connection between a flexible riser and a rigid spool; and

FIG. 16b shows a side view of FIG. 16a.

### DETAILED DESCRIPTION

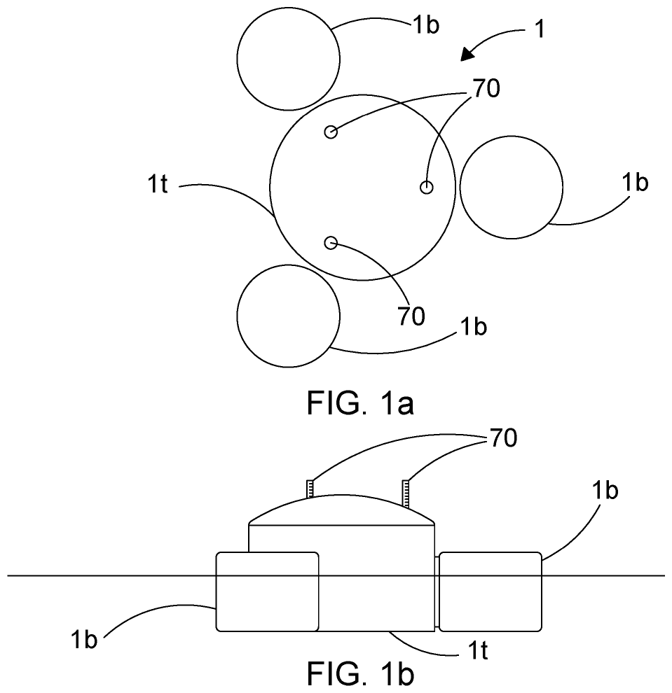

FIG. 1 shows an example of a subsea structure in the form of a hydrocarbon storage tank assembly 1 having a generally cylindrical storage tank 1t having an adjustable ballast feature in the form of three ballast tanks 1b spaced circumferentially around the central storage tank at regular intervals (in this example spaced at 120 degrees). The ballast tanks 1b are adapted to contain ballast and the amount of ballast contained in the ballast tanks 1b can be varied, which allows the buoyancy of the overall structure to be varied. The ballast tanks 1b have padeye (or other) connection points for mooring lines to be discussed below, which are optionally spaced angularly in a regular and optionally a symmetrical arrangement around the tank assembly at 120 degrees. The ballast tanks 1b are in this example equally angularly spaced around the storage tank 1t. The storage tank 1t optionally has a flat bottom and a domed roof, which can comprise depth gauges 70 in the form of cylindrical chambers extending vertically (parallel to the axis of the tank 1t) from the upper face of the tank 1t at spaced apart locations on the domed roof, and can be used to indicate the level of buoyancy of the tank 1t and the orientation of the tank 1t within the water (for example the orientation of the tank with respect to the horizontal axis) during the installation process.

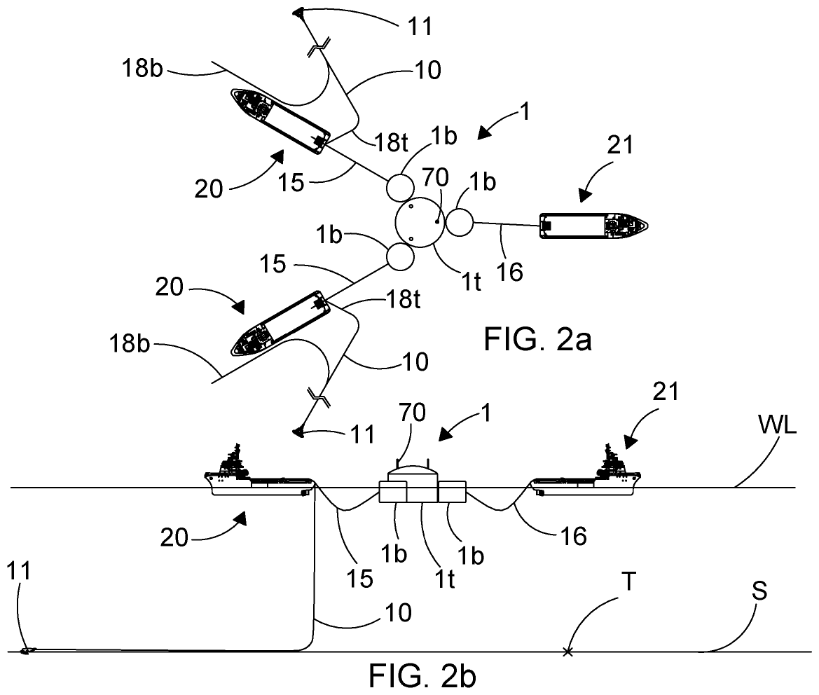

Before installation of the storage tank assembly 1, the installation site is optionally prepared by measuring the horizontal distance from an anchor point of each mooring line 10 on the seabed S, and a target installation site T (see FIGS. 2a and 2b). The distance can be measured by an ROV equipped with, for example, sonar- or laser-based measurement devices. Once the precise distance between these points is known, the length of mooring lines 10 from the anchor points 11 on the seabed S to the ends that will be tethered to the tank assembly 1 is determined so that the mooring lines 10 can be set at a length equal to the horizontal displacement between the anchor points 11 and the connection point on the subsea structure when in location on the target installation site, while being able to reach the deployment position of the tank assembly 1, which is spaced away from the target installation site in both horizontal and vertical directions. This measured length of mooring line may be part of the towing arrangement or connected to the towing arrangement such that the end of the measured length of mooring line may be recovered safely onto the lead vessel 21 for connection to the tank assembly 1. The mooring lines 10 are laid on the seabed S, converging at approximately 120 degrees towards the target installation site T of the tank assembly 1. The mooring lines 10 in this example are set at 150% of the water depth at the target installation site T.

FIG. 2a shows a plan view of the first step in one example of a method for installing a subsea structure, in this example the storage tank assembly 1 of FIG. 1, at a target installation site in an underwater location. In this example, two trailing vessels 20 are connected by tow lines 15 to the tank assembly 1, and one leading vessel 21 is connected to the tank assembly 1 by a leading line 16. In some other examples, a single trailing vessel 20 could be used, but as in this example, having two trailing vessels 20 allows an angular separation between the trailing lines, which helps to stabilise the tank assembly 1 during the installation operation.

FIG. 2b shows the storage tank assembly 1 buoyant at the deployment position, and floating on the surface WL of the water.

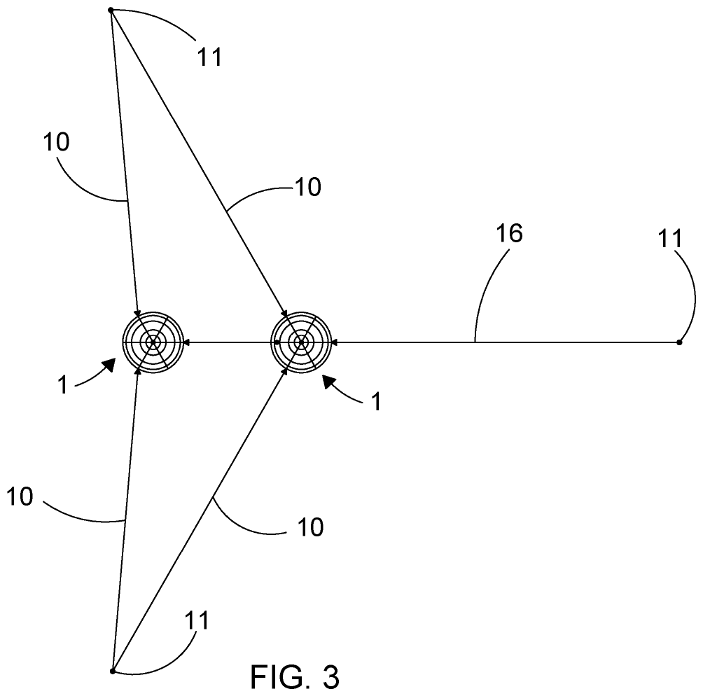

Initially, at the deployment position, with the tank assembly 1 on the surface, and awaiting installation as shown in FIG. 2, the angular separation of the two mooring lines is greater than 120 degrees, and can optionally be closer to 180 degrees, as can be seen in the plan view of the installation procedure in FIG. 3.

As can be seen in FIG. 2b, the two mooring lines 10 are anchored to the seabed by anchor points 11, and resist lateral movement of the anchored end of the mooring lines 10. The mooring lines 10 are anchored to the seabed by weights, or piles, or another means of anchoring that prevents movement of the mooring line 10 in a horizontal plane relative to the target installation site T. Displacement of the anchored end 11 of a mooring line 10 will result in the tank assembly failing to land in the target installation site, or being less controllable and unstable during descent. The angle between the mooring lines 10 is subject to determination of the optimum angle given the conditions at site and any obstacles in way of their route on the seabed S, and different values can be adopted in different examples.

The trailing vessels 20 recover the end of each pre-laid mooring line 10 from the seabed S whilst still connected to the storage tank assembly 1 via a trailing tow line 15, and can connect the mooring line 10 either directly to the tank assembly 1, or more commonly can connect the two components indirectly with a mooring line connector shackle. Alternatively a separate support vessel such as an ROV (remotely operated vehicle) may recover the end of the pre-laid mooring lines 10 and pass this across to the trailing vessels 20, or this may be carried out by a diver. The mooring lines 10 can be connected to the tank assembly 1 at connection points on the ballast tanks, or on the storage tank itself via the tow lines 15, which themselves will have been measured to ensure the tank assembly 1 lands on the target installation site T. These connection points can be padeyes, clamps, latches, ball and taper, shackles, or any other means of connection of a mooring line to a subsea structure.

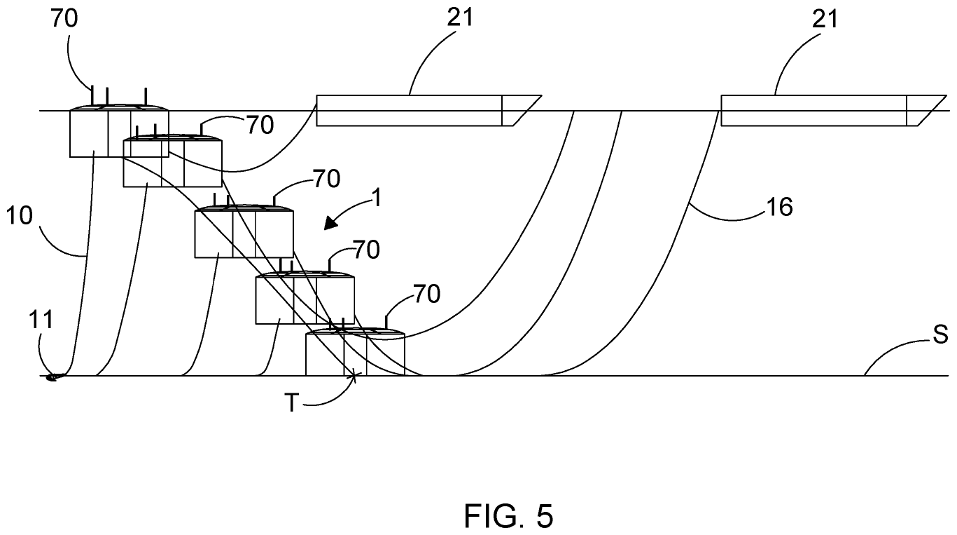

Once connected to the mooring lines 10 and to the leading line 16, the buoyancy of the tank assembly 1 is gradually decreased when the tank assembly 1 is moved into the deployment position as shown in FIG. 5, eventually transitioning from substantially positive to slightly positive or neutral buoyancy as indicated by the depth gauges 70, so that the tank assembly 1 becomes less buoyant. The buoyancy of the tank assembly 1 can be counteracted by the weight and tension of the mooring lines 10 as they are paid out from the lead vessel 21, so that the tank assembly 1 sinks through the water in a controlled manner to an equilibrium depth. Ballast can be added to the mooring lines 10 to facilitate or control sinking of the tank assembly 1. The transition point between positive and negative buoyancy can be monitored by observing the depth gauges 70 on the top of the tank 1t, and slowing the addition of ballast near to the transition point. Once the tank assembly 1 reaches its equilibrium depth, as dictated by the weight of mooring line 10 suspended underneath, ballast is added to one or more ballast tanks 1b (optionally to each tank to balance the ballast being added and maintain the “flat” orientation of the tank assembly 1 in the water).

The ballast is added until the tank assembly 1 reaches a greater depth, at which point the tank assembly 1 can continue its controlled descent with the mooring lines 10 and the leading line 16 acting as additional ballast as well as stabilising the tank assembly 1 during descent and landing. The ballast can take the form of seawater, concrete, mud, or another material, or any combination thereof. Alternatively, to reduce the buoyancy of the tank assembly 1, water can be allowed to enter the tank 1t in a controlled manner, while optionally allowing venting of the air inside the tank.

The mooring lines 10 are flexible, and can incorporate ballast (which can be integral to the mooring lines 10 and/or can be separately attached thereto), and so the mooring lines 10 themselves exert a downward sinking force on the tank assembly 1 acting to sink the tank assembly 1. The downward force exerted by the mooring lines 10 is in proportion to the amount of mooring line 10 that is unsupported between the seabed S and the structure. The mooring line 10 can be a chain, or a rope, or another material suitable for marine mooring applications.

The leading line 16 and mooring lines 10 are connected to the storage tank assembly 1 at symmetrically spaced apart locations with an angular difference between each tether point, e.g. at diametrically or diagonally opposite locations, so that downward force exerted by the leading line 16 and mooring lines 10 is applied to symmetrically spaced locations on the tank assembly 1, thereby balancing the force and enhancing the stability of the tank assembly 1.

One example of a controlled descent path of the tank assembly 1 is shown in FIG. 5. During initial movement of the tank assembly 1 away from the deployment position through the water column, the tank assembly 1 undergoes greater horizontal displacement than vertical displacement, leading to movement along a generally convex curved path away from the deployment position. As the relationship between the buoyancy of the tank assembly 1 and the ballast of the tank assembly 1 and/or weight of the mooring lines 10 and/or the leading line 16 attached to the tank assembly 1 changes, the path of the tank assembly 1 transitions to become more linear, with the horizontal and vertical components of the displacement of the tank assembly 1 being generally equal to each other.

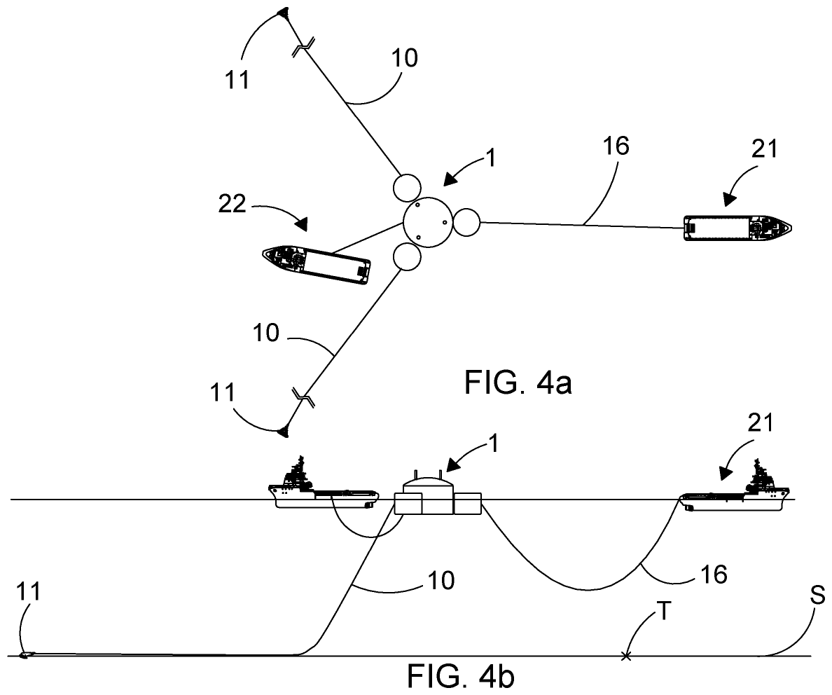

FIGS. 4a and 4b show the mooring lines 10 after connection to the storage tank assembly 1. As can best be seen in FIG. 4a, two mooring lines 10 are attached to the storage tank assembly 1, at spaced apart locations on one side of the tank assembly 1. The leading line 16 is connected at an opposite side of the tank assembly 1 to the mooring lines 10, typically opposite to a bisector between the two mooring lines 10 for improved stability and balance. The storage tank assembly 1 is towed by the leading vessel 21 in a direction that is opposite to the bisector of the two mooring lines 10. In other words, the positioning of the leading and mooring lines 16, 10 is selected such that the vector of the forces applied to the structure by the single leading line 16 is resolved in the diametrically opposite direction to the vector sum of the forces applied to the structure by the two mooring lines 10.

Attaching the mooring lines 10 at connection points on the storage tank assembly 1 that are angularly spaced around the tank assembly 1 allows positioning to be controlled in different horizontal directions and can improve control of the heading and position during the descent and landing operation. The angular spacing between the two mooring lines 10 and between at least one of the mooring lines 10 and the leading line 16 is approximately equal, with the angular spacing between adjacent lines approximately 120 degrees. However, for alternate sites with different prevailing subsea conditions, this angular spacing can be adjusted to suit.

Before sinking of the tank assembly 1 from the deployment position, and after both of the pre-installed mooring lines 10 are connected to the tank assembly 1, the trailing vessels 20 can pay out their tow lines, which can be disconnected from the tank assembly 1, freeing the trailing vessels for other duties. During this time the lead vessel 21 moves forward, adjusting its position as necessary to ensure tension is maintained on the leading line 16 and the mooring lines 10, thus controlling the heading, drift and orientation of the tank assembly 1. In certain cases one or more trailing vessels can remain connected to the tank assembly 1 during deployment of the tank assembly 1 to the target installation site (not shown) in order to further control the descent of the tank assembly 1, by adjustment of the weight of the catenary observed by the tank.

During de-ballasting of the tank assembly 1, as the tank assembly 1 moves forward with a horizontal component of movement from the deployment position towards the target installation site during later installation steps, the anchored ends 11 of the mooring lines 10 remain fixed in position. As a result, the angular separation of the mooring lines 10 decreases during the movement of the tank assembly 1 to the target installation site and subsequent landing on the target installation site. In this example, by the time the tank assembly 1 has reached the target installation site, the mooring lines and the tow line are peripherally spaced about the tank assembly 1 by equal amounts as is best shown in FIG. 3. This helps to balance the forces acting on the tank assembly, assisting in controlling the horizontal positioning and the heading of the tank assembly 1.

FIGS. 4a and 4b also show the lead vessel 21 about to move away from the deployment position and begin to tow the storage tank assembly 1 towards the target installation site. The leading line is flexible and incorporates ballast, and can be ballasted with additional weights if required, and in this example adopts a catenary configuration between the storage tank assembly 1 and the leading vessel 21, to which the leading line is connected. The leading line can comprise a chain, or rope, or another material that is adapted for marine towing uses.

The lowering operation may include a number of different methods to reduce the buoyancy of the tank assembly 1, for example, gas-filled compartments of the ballast tanks 1b can be flooded, fluids in the ballast tanks 1b can be replaced by denser fluids, and/or weights can be added to the tank assembly 1 as described above.

Once the tank assembly 1 is neutrally buoyant and starts sinking, the tension in the mooring lines 10 can reduce slightly and at this stage, the lowering operation can be controlled by the lead vessel 21 adjusting the applied force and length of the leading line 16.

The tank assembly 1 is towed via the leading line 16 and leading vessel 21 from the deployment position spaced laterally away from the target installation site to an installation position above the target installation site for landing on the installation site. As the mooring lines 10 are connected between the seabed anchors 11 at their far ends remote from the tank and the corners of the ballast tanks 1b, the towing of the tank assembly 1 by the leading vessel 21 causes the tension in the mooring lines to increase and the tank assembly 1 to sink through the water moving both horizontally and vertically in a linear or arcuate path towards the target installation site.

FIG. 5 shows a step-by-step illustration of the descent and landing procedure once the tank assembly 1 has reached neutral buoyancy. The mooring lines 10 are initially tensioned in a substantially vertical direction. As the tank assembly 1 descends through the water, the lead vessel 21 applies sufficient tension to the leading line 16 to keep the tank assembly 1 moving horizontally during the descent, so that the mooring lines 10 are under balanced tension.

The tension in the mooring lines 10 and the leading line 16 maintains stability of the tank assembly 1 in the water, so that the tank assembly 1 descends in a controlled manner, moving laterally in a horizontal plane as well as vertically through the water column with respect to the target installation site until it is located directly above the target installation site on the seabed S. This method of deployment can allow more accurate placement of the tank assembly 1, especially in crowded fields where existing subsea structures can act as obstacles and inhibit deployment, especially of larger structures. Some examples of the method can be less sensitive to uncontrolled lateral movements of the tank assembly 1 away from the target installation site, resulting from, for example, tide or current forces in the water.

As the leading vessel 21 tows the storage tank assembly 1 laterally away from the anchored mooring lines 10 and towards the target installation site as it descends, the catenary configuration of the leading line 16 can be adjusted in order to control the amount of ballast applied to the tank assembly 1 by the leading line. This can help to maintain the tank assembly 1 in a generally stable horizontal plane. In other words, as the leading line 16 is tensioned, resulting from the movement of the leading vessel 21 away from the deployment position and the storage tank assembly 1, the leading line 16 is gradually paid out from the tow vessel taking into account speed of the leading tug 21, in order to control the catenary configuration of the leading line 16, and hence exert the correct amount of weight on the tank assembly 1 from the ballast in the leading line 16. The catenary configuration of the leading line 16 can be adjusted during descent of the storage tank assembly 1 to balance the tank assembly 1 during the descent, so that the tank assembly 1 descends in an the desired path (optionally an arcuate path) through the water.

The paying out of the leading line 16 by the leading vessel 21 as it moves laterally and the corresponding sinking of the tank assembly 1 through the water results in the leading line 16 reaching sufficient length whereby the leading line 16 begins to be deposited on the seabed S. As the tank assembly 1 descends further, and also moves horizontally under the guidance of the leading vessel 21, the mooring lines 10 are also increasingly laid down on the seabed S. As more length of the lines 10,16 is deposited on the seabed S an equilibrium position is achieved wherein the tension in the lines is balanced relative to one another and the angles between the lines are equal at 120 degrees.

To assist with the controlled descent, ballasting of the tank assembly 1 can be continued, either through for example increasing the ballast in the ballast tanks, or by attaching weights, or by flooding designated compartments within the storage tank. Designated ballast compartments within the storage tank are of finite volume and located so that when ballasting commences, the tank assembly 1 is not destabilised, and does not roll or tip. For example, a ballast compartment may be integrated into the centre of the storage tank, or may form a ring around the base circumference of the storage tank, either from a single compartment or multiple compartments, or the ballast compartments may take some other configuration. Optionally the ballast compartment in the storage tank can be centralised and symmetrical within the tank, so that filling the ballast compartment in the storage tank reduces the buoyancy of the tank assembly 1 but does not affect the trim. Optionally the outer ballast tanks can be filled initially, until the threshold between positive and negative buoyancy is approaching, and thereafter manipulation of the ballast can be achieved by filling and draining the centralised tank to cause the tank assembly 1 to rise and ascend without affecting the trim of the tank assembly 1 (e.g. the angle of the tank assembly 1 in the water with respect to the horizontal axis).

The ballast compartments may have a valve that is accessible either to an ROV or to a diver. The ROV may be docked onto the tank, or it may be operated via a downline from an ROV control vessel (22, FIGS. 4a and 4b).

Prior to landing the structure on the seabed S in the target installation site, and/or during the descent, the position, heading, and depth may be checked by optional transponder devices fitted to the structure, or by ROV, or another suitable method. The ROV may be docked to the tank for measurement of, for example, the angle of the storage tank assembly 1 during descent and local control or operation of flooding valves. Once the tank assembly 1 is directly above the target installation site, optionally within 5-10 m of vertical separation between the tank assembly 1 and the target installation site, the final lowering step can be performed using a combination of adjustment of ballast and buoyancy on the ballast tanks 1b and the storage tank 1t, and leading line 16 tension.

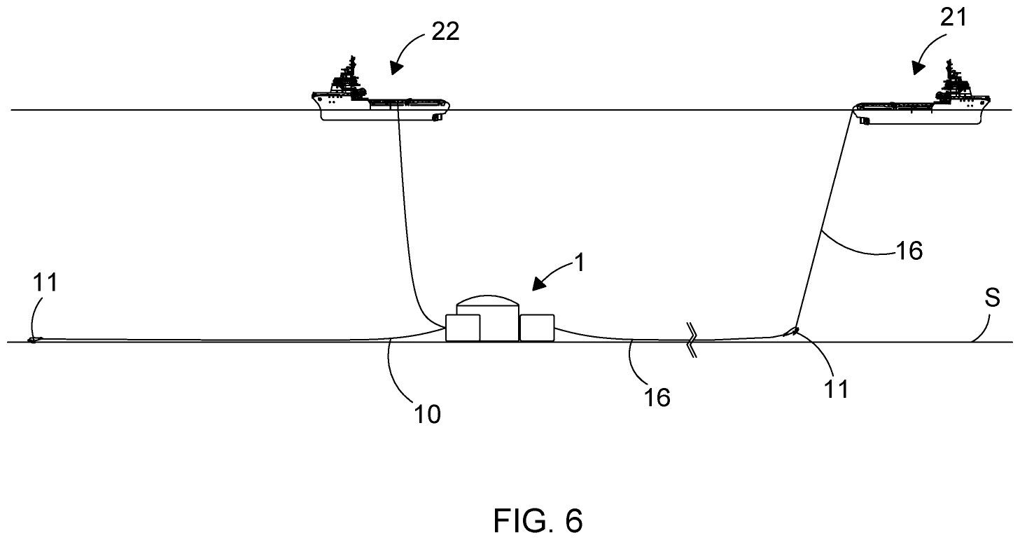

As shown in FIG. 6, once the storage tank assembly 1 is in position in the target installation site on the seabed S, the lead vessel 21 pays out more leading line 16, which will act as a third mooring line. An anchoring device 11 is connected to the end of this third mooring line prior to deployment to the seabed S. The mooring line is then laid on the seabed S under tension to minimum slack. At this stage the tank assembly 1 is anchored to the seabed S by the two mooring lines 10 initially laid before the descent, and by the leading line 16 now acting as a third mooring line; all lines 10,16 are symmetrically and regularly spaced around the tank assembly 1 as described above, and each exerting a balanced downward force on the tank assembly 1. The lines 10, 16 extend from the tank assembly 1 at an angular spacing of 120 degrees to their respective anchors, as substantially shown in the plan view of the tank assembly 1 on the seabed in FIG. 3.

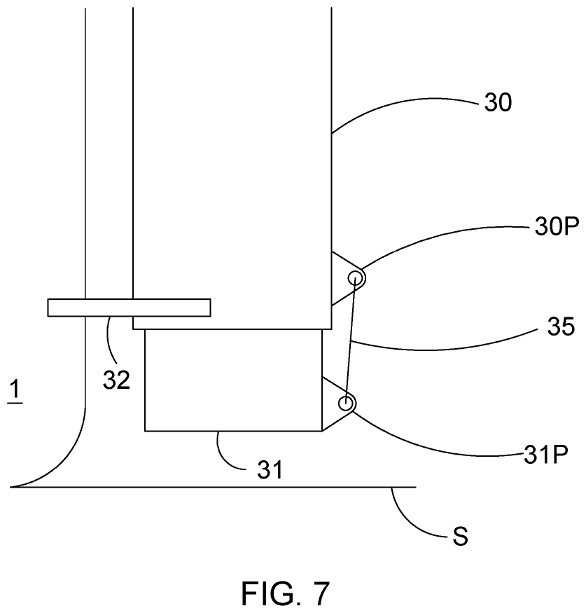

The tank assembly 1 can remain anchored in position by the mooring lines as well as by any ballast contained in the tank assembly 1. Alternatively or additionally, as seen in FIG. 7, the tank assembly 1 can comprise one or more pile sleeves 30, equally spaced around the tank assembly 1, which are adapted for retention of piles 31 which can optionally be deployed into the pile sleeves when the tank assembly 1 is launched into the water, and retained within the pile sleeve 30 during the towing of the tank assembly 1 to the deployment position. The piles are lowered to the seabed while in the pile sleeves, during the towing and landing procedures. The pile sleeves 30 are connected to the tank assembly 1 by connectors 32. The connectors 32 can be rods, clamps, or another suitable means of connection between the two structures. Each pile 31 is optionally retained in position within the pile sleeve by a padeyes connected between each pile 31 and its respective pile sleeve 30. Each pile 31 has a padeye 31p on an outer surface towards the pile's seabed-facing lower end, with the pile sleeve 30 having a padeye 30p directly above the pile's padeye 31p. The two padeyes 30p, 31p are adapted to be aligned with one another (a spline or other rotational connector can be provided to maintain the alignment) and the two padeyes 30p, 31p can be connected using one or more sacrificial slings 35 in the form of lengths of fibre, rope, chain or other connection. Alternative means of connection other than the padeyes, for example latches, clamps, shackles or the like, can also be used.

While the pile sleeve 30 and the pile 31 are connected by the sling 35 or other connector, the pile 31 cannot be deployed from the pile sleeve. Once the tank assembly 1 is landed on the target installation site, the connection can be broken, for example using an ROV to cut the sacrificial sling 35, or change the configuration of the latch or other retention device, and the pile 31 is then released from the pile sleeve and engages the seabed S ready to be driven into the seabed S in a conventional manner, with the desired alignment of the pile relative to the tank assembly 1 being determined by the relative angles of the pile sleeve with the central vertical axis of the tank 1t. For safety, the pile 31 can be lifted slightly away from the seabed S by a crane on a vessel or by an ROV, to slacken off the sling 35 prior to cutting, to prevent damage to the ROV during the cutting process. The pile sleeve 30 can act as a guide for positioning of the pile 31 during anchoring, to ensure the pile 31 remains vertical during installation.

The mooring lines can be left in place in addition to the piles, or alternatively they may be removed such that the tank assembly is anchored solely by the piles. The mooring lines can additionally have unconnected tails left in place connected to the same anchors at the ends of the mooring lines after anchoring of the tank assembly, for tethering of an additional structure.

In certain examples the storage tank assembly 1 can be towed in one horizontal direction towards the target installation site by the leading line, and the horizontal movement of the tank assembly towards the target installation site can be controlled by a second, or further, tow line applying a force in the opposite direction for at least some of the time during the movement of the tank assembly. Thus, two or more tow vessels can be used for the installation operation and can be connected to the tank assembly at different locations, e.g. at opposite ends of the tank assembly. Each tow line can be attached to a respective tow vessel, with a leading tow line attached to the forward end of the tank assembly closest to the target installation site, and the other, trailing, tow lines attached to connection points which connect to the mooring lines towards the rear of the tank assembly, further away from the target installation site.

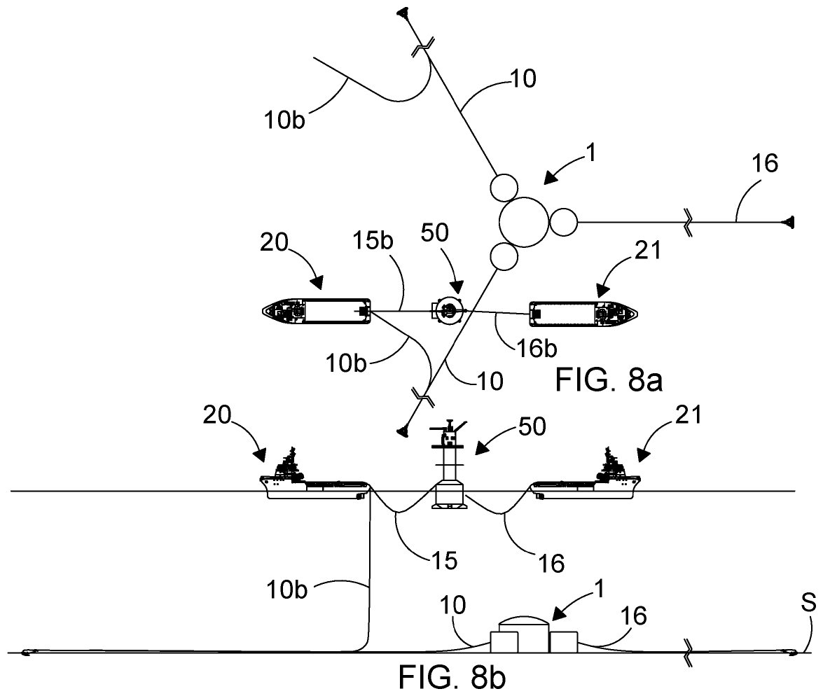

After anchoring of the tank assembly, a floating structure can be tethered above the tank assembly 1, in this example an offshore production buoy 50. The buoy 50 in this example is towed to the installation site for use, optionally at the same time as the tank assembly 1. FIGS. 8a and 8b show a lead vessel 21 connected to the buoy 50 by a leading line 16b, and a trailing vessel 20 connected to apply a towing force in an opposite direction by a tow line 15b, which acts to stabilise the buoy 50 under tow. One or more tow lines 15b can be added to the buoy 50 for additional stabilisation and reduction in pitch, roll, and yaw of the buoy 50 under tow.

Once the buoy 50 has been towed to the installation site the trailing vessel 20 picks up a first unconnected tail of a pre-installed buoy mooring line 10b connected to the same anchor 11 that is anchoring the storage tank assembly 1 to the seabed S via the mooring line 10. The unconnected tail of the buoy mooring line 10b can be laid out on the seabed S during the pre-installation procedure for the tank assembly 1, or tethered to a surface buoy for pickup by a surface vessel. Alternatively, the buoy mooring lines 10b for tethering the buoy 50 to the anchor 11 can be attached to the top of the tank assembly 1 during load-out, so that the mooring lines 10b can be picked up from the tank assembly 1 during the installation process for the buoy 50, and thereafter connected to the buoy 50 in the same way as the tail of the mooring line 10.

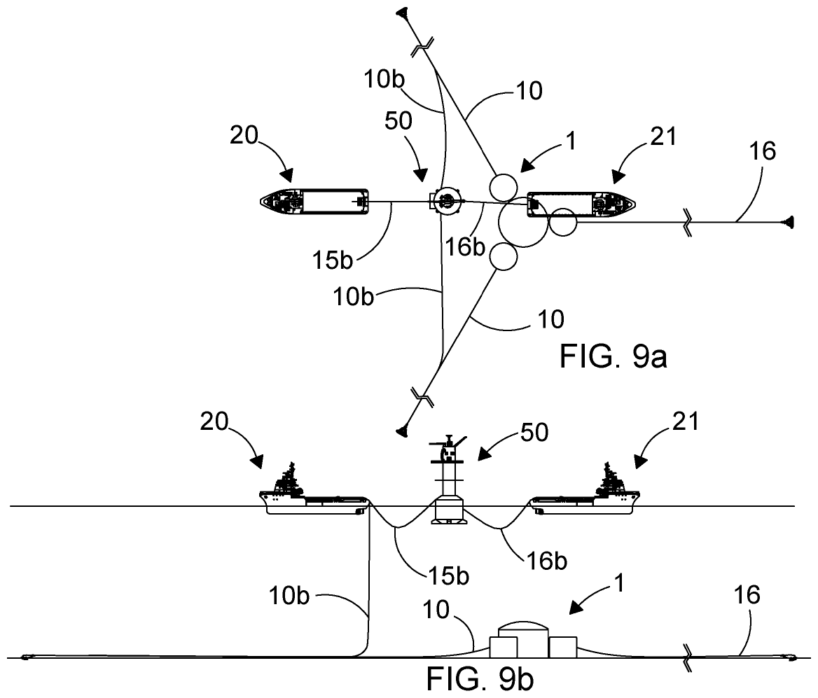

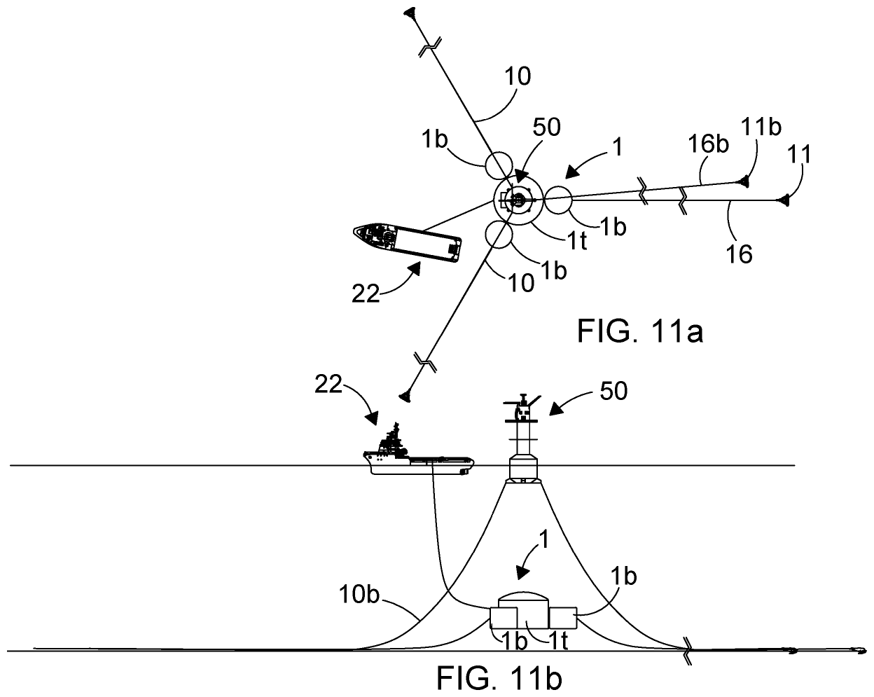

FIGS. 9a and 9b show the tails of the first and second buoy mooring lines 10b being connected to the buoy 50, via the towing line on the back end of the vessel. The mooring lines 10b are connected at approximately opposing directions to each other, with the tow line 15b and the leading line 16b bisecting the mooring line 10b connections, such that the buoy 50 is connected to lines at four spaced points, which are regularly and symmetrically spaced apart but are not in this example necessarily equally spaced, as is best shown in the plan view of FIG. 11a. Optionally the leading line 16b and the mooring lines 10b for the buoy are equally spaced, as the leading lines and mooring lines 16,10 of the tank assembly 1b. The connection for the mooring line 10b to the buoy can be in the form of padeyes, latches, clamps, or another suitable mooring connection.

The mooring lines 10b are connected to the buoy 50 well above the seabed S, so the horizontal position of the buoy 50 will be affected by the magnitude and direction of the prevailing current and other forces acting laterally upon it. The tension in the mooring lines 10b for the buoy 50 is determined in concert with the length of the mooring lines 10b to minimise the horizontal movement of the buoy 50 after installation. The mooring lines 10b are optionally connected at their lower ends to the same anchors 11 that anchor the mooring lines 10 for the storage tank assembly 1 or at a point along the mooring lines 10 for the storage tank assembly 1, or to independent anchors (not shown). The mooring lines 10b for each of the buoy 50 and the tank assembly 1 can be the same length, but in this example the tails of the mooring lines 10b that are connected to the buoy 50 are longer than those connected to the tank assembly 1, to take account of the additional vertical distance of the buoy 50 from the seabed S. In an alternative example, where the mooring lines 10b for the buoy 50 are connected to a point on the mooring lines 10 of the tank assembly 1, the mooring lines 10b of the buoy 50 can be shorter than or the same length as the mooring lines 10 of the tank assembly 1.

Once both of the mooring lines 10b are connected to the buoy 50, the trailing vessel 20 can commence paying out of tow line 15b and can disconnect from the buoy 50 being towed. During this time the lead vessel 21 can move forward towards the anchor 11 at the end of leading line 16 forming the third mooring line of the tank assembly 1, adjusting position as necessary to ensure tension is maintained on the leading line 16b, and on the mooring lines 10b, thus controlling the heading and drift of the buoy 50, essentially as described for the installation of the tank assembly 1 above.

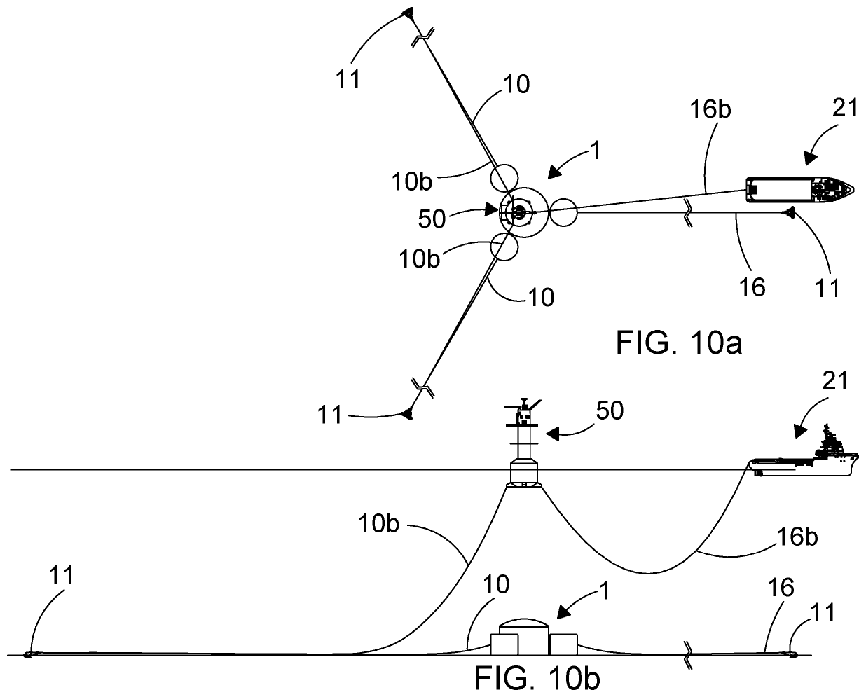

FIGS. 10a and 10b show the configuration after the trailing vessel has been disconnected from the buoy 50. The lead vessel 21 begins to move towards the anchor 11, paying out more of the leading line 16b as it moves in order to control the ballast applied to the buoy 50 during the installation operation. The movement of the lead vessel 21 acts to tow the buoy 50 laterally across the surface of the water. The lead vessel 21 adjusts its position until the buoy 50 is positioned directly vertically above the tank assembly 1. The lead vessel 21 can then pay out leading line 16b, adjusting the position of the vessel 21 as required to ensure the buoy 50 is kept above the tank assembly 1. As the leading line 16b is paid out, it rests on the seabed S, and improves the stabilisation of the buoy 50. This paid out leading line 16b acts as a third mooring line for the buoy 50, and the end terminal of the leading line 16b can be connected to an anchor 11b which connects to the mooring line for the tank assembly 1, or if the tank assembly 1 has a third mooring line and an anchor 11, the same anchor point can be used for the leading line/third mooring line 16b of the buoy 50. The leading line 16b is laid under tension to minimise slack and ensure the buoy 50 is maintained in position above the tank assembly 1.

After the buoy 50 is moored in position over the tank 1t as shown in FIGS. 10 and 11 it can be tethered to the tank 1t. The buoy 50 is extremely buoyant and in the FIGS. 10 and 11 moored configuration normally floats much higher in the water than in its operating configuration when it is tethered to the tank 1t. In order to connect the tethers, the vertical distance between the tank 1t and the buoy 50 is temporarily reduced by de-ballasting of the anchored tank assembly 1 to lift it from the seabed S by a short distance under its own buoyancy, with the mooring lines 10 restricting floating of the tank assembly 1 to the surface by virtue of the tension in the lines 10/16 and ballast applied by the lines 10/16. This lifting operation reduces the distance between the tank 1t and the buoy 50 and facilitates connection of tethers 55 between the buoy 50 and the tank assembly 1 as will now be described.

The tank assembly 1 can be connected to a ballast control/ROV vessel 22 by a corresponding ROV. The ballast control vessel can supply ballast to the tank assembly 1 by means of a ballast line 221. The ROV can open ballast compartment valves to permit removal of ballast, either from the designated compartments within the storage tank 1t, or the ballast tanks 1b, or can add buoyant fluid to the ballast tanks of the tank assembly 1 via the ballast line 221. The ballast can be extracted to the vessel for return to the tank assembly 1 after tethering of the buoy 50 is completed. The tank assembly 1 then lifts off the seabed S under the force of its own buoyancy as shown in FIG. 11b, and is constrained by the mooring lines 10 that remain connected to the tank assembly 1. Tension increases in the mooring lines 10 as the tank assembly 1 travels off the seabed, limiting the ascent of the tank assembly 1.

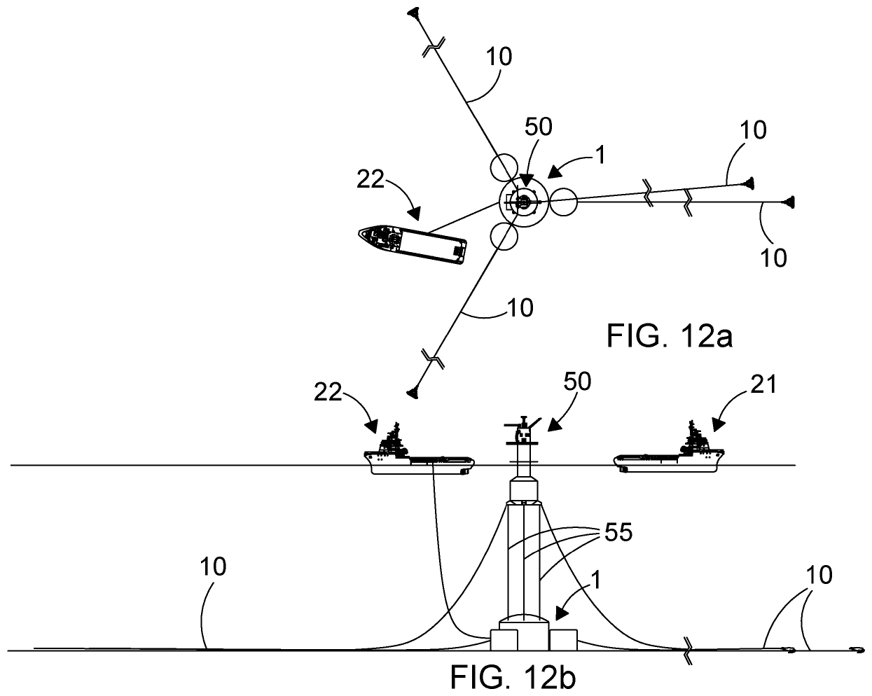

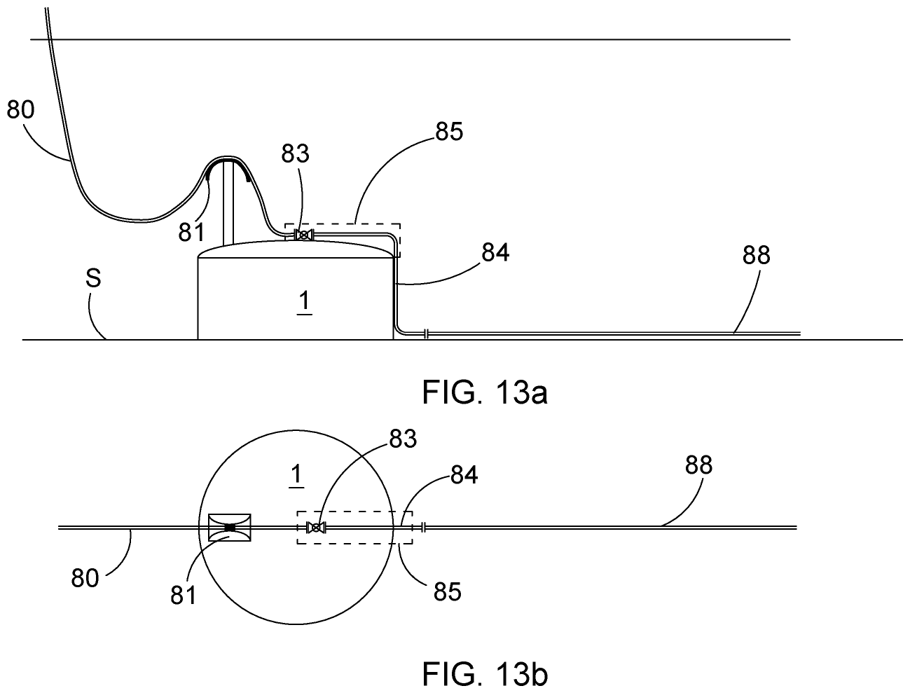

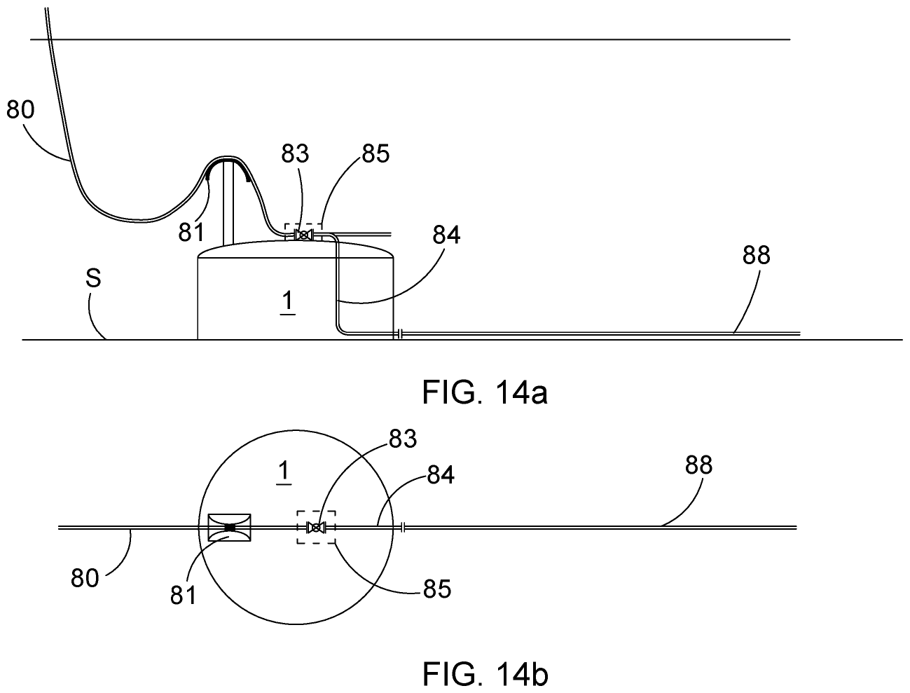

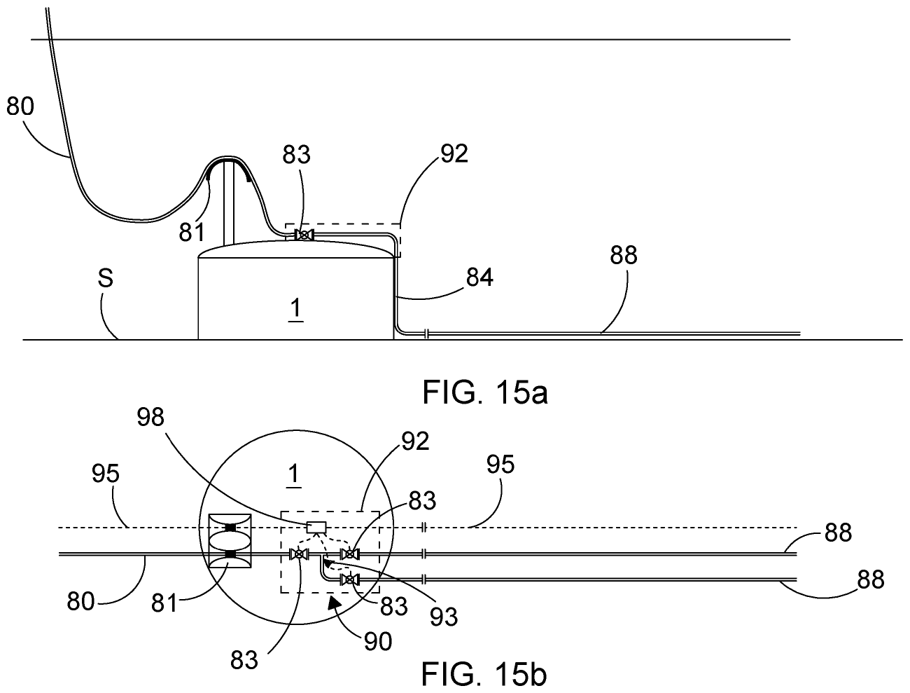

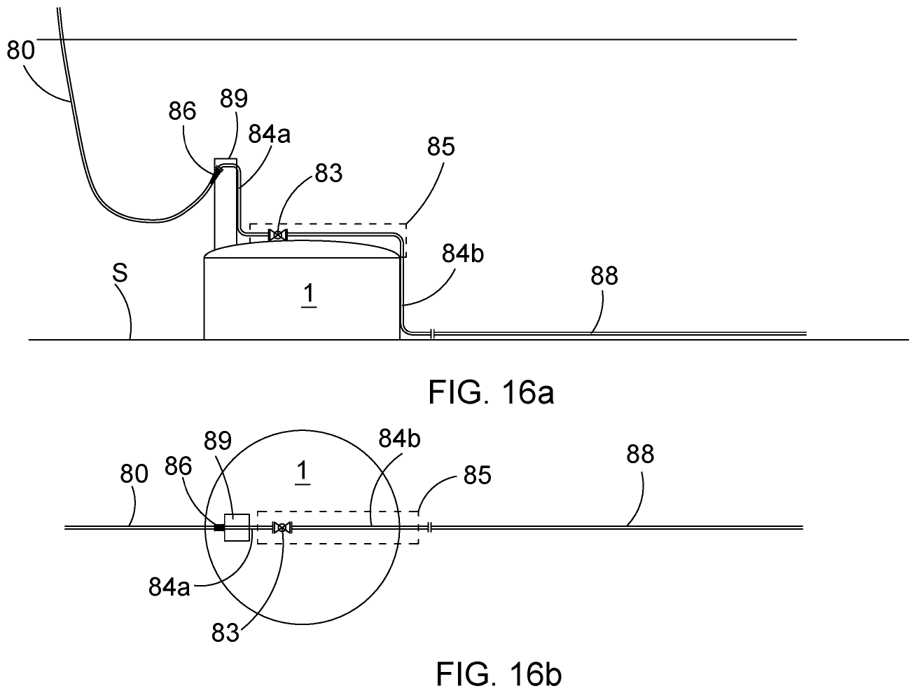

Once the tank assembly 1 has been sufficiently de-ballasted to lift it clear from the seabed S as shown in FIG. 11b, and the buoy 50 and the tank assembly 1 approach each other, tethers 55 are connected between the buoy 50 and the tank assembly 1, as illustrated in FIGS. 12a and 12b. The mooring system comprising the lines connected to the buoy 50, and the lines connected to the tank assembly 1, controls and maintains the relative positions of the buoy 50 and the tank assembly 1 during the process. The tethers 55 are set to a length that will pull the buoy 50 down from the mooring position shown in FIG. 11b, into the operating position shown in FIG. 12b when the tank assembly 1 is on the seabed.

After tethering of the buoy 50 and the tank assembly 1, ballast is returned from the vessel 22 to the tank assembly 1, and the tank assembly 1 sinks back down onto the seabed S. The descent of the tank assembly 1 pulls the buoy 50 vertically downwards to a working depth at the operating position shown in FIG. 12b, and also applies sufficient tension to the tethers 55 to keep the buoy in position over the tank assembly 1 during operations. This process of de-ballasting the tank assembly 1, or only completing the final ballasting step to lower the tank assembly 1 to the seabed after connection of the tethers 55, makes use of the considerable ballast available to the tank assembly 1 to sink the very buoyant buoy to the desired working depth and to apply the correct tension to the tethers in a single step, while allowing the tethers to be attached while still at a relatively low tension.

In an alternative example of the buoy installation method, the storage tank assembly remains on the sea bed and the buoy is pulled down towards it by attachment of ballast weight to pre-defined locations on the mooring lines connected to the buoy. This increases the draught of the buoy and allows connection of tethers between the buoy and the tank assembly. The additional ballast is released after connection of the tethers to float the buoy to the working depth. For additional stability and security, mooring lines can still be connected to the buoy after the ballasting and connection operation is complete.

Removal of the buoy or replacement of the tethers may be carried out using the installation method in reverse, to either increase the draught of the buoy or to increase the buoyancy of the tank assembly to reduce the distance between the tank assembly and the buoy.

The mooring system described here is particularly useful when decommissioning and re-floating the storage tank assembly once it has completed operations at a given site. Due to the multiple unknown factors that affect buoyancy of a marine structure after it has been in position for some time, for example marine growth on the tank assembly 1, contents of the tank 1t, material loss due to corrosion, or the suction effects of the soils in the seabed, ascent of the tank assembly 1 being re-floated can be unpredictable. The mooring system offers additional control of the ascent of the tank assembly, thus mitigating rapid and uncontrolled breakout of the tank assembly from the seabed and subsequent uncontrolled ascent.

Once the structures have been tethered together, dynamic flexible risers are installed between the buoy 50 and fluid flow lines located on the seabed to allow fluid communication and flow of production fluids from the subsea wells to the buoy 50, via the subsea fluid flow lines from the wellheads and the riser.

In certain examples, the storage tank assembly 1 may be used as a base for subsea equipment thereby avoiding the requirement for a separate gravity base or anchor for other pieces of subsea equipment. In one example, the storage tank assembly 1 comprises a riser support structure in the form of a fixed or optionally a lazy “S” riser support arch 81, adapted to support and anchor a dynamic flexible riser 80, thereby avoiding a requirement for a separate base for the riser 80. The dynamic flexible riser 80 forms an S-shape as it drapes over the support arch 81. The riser 80 then connects to a rigid spool 84 via a valve 85 attached to the flattest part of the domed roof of the tank assembly 1. The rigid spool 84 then bends at 90 degrees to pass vertically down a side of the tank assembly 1, and bends at 90 degrees again to travel along the seabed S and connect to a hydrocarbon pipeline 88 laid on the seabed S. Providing anchoring and support mechanisms on the tank assembly 1 (regardless of how it has been deployed on the target installation site) mitigates the need for separate seabed anchors and bases for the riser supports, thereby de-cluttering the field around the tank assembly 1 and simplifying design of the field, and hence forms a separate aspect of the present invention.

The valve 83 and the first section of the rigid spool 84, up to and including the first 90 degree bend, are protected from damage, for example from dropped objects, by a protective housing 85. The housing 85 can be rigid and made from metal or plastic, or another material that is sufficiently resistant to water pressure at the installation depth of the storage tank assembly 1. The rigid spool 84 may be routed inside the structure of the storage tank assembly 1 to provide further protection.

In a further example, a dynamic flexible riser 80 is supported by a fixed or a lazy “S” riser support arch 81 as above, however, a portion of the rigid spool 84 is located within the storage tank assembly 1 rather than wholly externally to the tank assembly 1. The rigid spool 84 connects to the riser 80 through a valve 83 on the roof of the tank assembly 1 as before. The rigid spool 84 then bends at 90 degrees to pass through a channel in the roof of the storage tank assembly 1 towards the seabed S. When the rigid spool 84 nears the end of the channel at the base of the tank assembly 1, it again bends at 90 degrees to travel horizontally, passing through a side of the storage tank assembly 1, and connecting to a pipeline 88 laid on the seabed S. The channel through which the rigid spool 84 passes can be sealed such that it is watertight and resistant to ingress of seawater even at high pressure.

The valve 83 is protected by a protective housing 85 as before.

In an alternative example, the storage tank assembly 1 comprises a fixed or lazy “S” support arch 81, supporting a dynamic flexible riser 80 feeding into a valve connection 83 as before. In this example, the valve 83 connects the riser to a branched connection 93, where a single conduit branches into two, which then go on to connect to two rigid spools 84 via valves 83 on each conduit. Each rigid spool 84 connects with one of two pipelines 88 laid on the seabed S as before.

The valves 83 also have umbilical cables 95 connecting to them at one end, and connecting to an umbilical subsea distribution unit 98 at the other end. The umbilicals 95 and the subsea distribution unit 98 can be housed within the storage tank assembly 1, or can be on the roof of the tank assembly 1, protected along with the manifold connection 90 by a protective housing 92, formed from rigid material as before. Thus manifolds can also be mounted on the tank assembly 1 avoiding the need for a separate base for the manifold. In a further example, the manifold can be a subsea isolation valve, mounted on the top of the tank 1.

A second fixed or lazy “S” riser support arch 81 supports an umbilical cable 95 travelling between the subsea distribution unit 98 and the buoy 50. Further umbilical cables can be connected to the subsea distribution unit 98 if required.

In a further example, the storage tank assembly 1 comprises a dynamic riser support structure 89, sited on the roof of the storage tank assembly 1, and adapted to support a dynamic flexible riser 80. The dynamic riser support structure 89 guides and supports the rigid spool 84 and dynamic flexible riser 80, anchoring it so that the dynamic riser support structure 89 is resistant to movement under the influence of environmental forces and/or movement of the upper end of the dynamic flexible riser 80. The support structure can comprise a frame, a box or another structure capable of resisting movement of the rigid spool connected to the dynamic riser.

As before, the flexible riser 80 connects to a rigid spool 84, but in this configuration the point of connection is located within the dynamic riser support structure 89. The connection point is supported and protected from torsional and tensive forces by a connector 86, possibly a clamp, or sheath, or the like, that permits reduced movement of the flexible riser 80, with the resistance of the connector 86 to movement optionally increasing towards the end that connects to the rigid spool 84. Thus, movement of the flexible riser 80 relative to the rigid spool 84 decreases towards the connection point of the riser 80 and the spool 84. The rigid spool 84 is anchored, clamped, or otherwise secured to the dynamic riser support structure to mitigate movement of the rigid spool 84, and potential detachment from the fluid pathway. The rigid spool 84 can form a u-bend within the dynamic riser support structure 89, such that it passes outside of the dynamic riser support structure 89 and passes vertically downwards to the roof of the tank assembly 1. The rigid spool 84 then bends at 90 degrees and travels horizontally along a portion of the roof of the tank assembly 1 to a valve 83.

The valve 83 connects the first rigid spool 84a with a second rigid spool 84b, which then travels across the remaining portion of the roof of the tank assembly 1, bending at 90 degrees to travel vertically towards the seabed S, before bending at 90 degrees again to connect to a pipeline 88 laid on the seabed S.

Portions of the first and second rigid spools 84a, 84b, and the valve 83 connecting them, are protected by a protective housing 85 that is adapted to encase or house the valve 83 and at least a portion of the rigid spools 84a, 84b in order to protect the components from damage. The protective housing 85 is formed from plastic, metal, or another rigid material that is capable of withstanding the pressure of water at the installation depth of the tank assembly 1, as before.

1. A method for installing a subsea structure at a target installation site in an underwater location, the method comprising connecting at least one mooring line to the structure, connecting at least one leading line to the structure, and towing the structure via the leading line from a deployment position spaced laterally away from a target installation site to an installation position above the target installation site, and moving the structure both vertically and horizontally through the water between the deployment and installation positions.

2. A method as claimed in claim 1, the method including anchoring at least one mooring line to at least one anchor point, wherein the length of the at least one mooring line between the anchor point and the structure is substantially equivalent to the distance between the anchor point and the target installation site.

3. A method as claimed in claim 1, including floating the structure on the surface of the water at the deployment position, and adjusting at least one of the buoyancy and ballast acting on the structure to facilitate sinking of the structure through the water, while controlling the orientation of the structure in the water during sinking of the structure by varying tension in at least one of the at least one mooring line and the at least one leading line.

4. A method as claimed in claim 1, the method including connecting the at least one leading line in a catenary configuration between the structure and a towing vessel, and paying out said leading line as the towing vessel tows the structure laterally towards the target installation site.

5. A method as claimed in claim 1, the method including towing the structure by the at least one leading line in a lateral direction away from the at least one anchored mooring line, towards the target installation site.

6. A method as claimed in claim 1, the method including connecting the at least one leading line and the at least one mooring line to the structure at spaced apart locations.

7. A method as claimed in claim 6, wherein the connection points of the lines are symmetrically positioned.

8. A method as claimed in claim 6, the method including connecting at least two mooring lines and at least one leading line to the structure at circumferentially spaced apart locations on the structure, wherein the at least one leading line is connected at an opposite side of the structure to the at least two mooring lines, and wherein the at least one leading line connection is opposite to a bisector between the at least two mooring line connections.

9. A method as claimed in claim 8, the method including towing the structure by the at least one leading line in a direction opposite to the bisector between the at least two mooring lines.

10. A method as claimed in claim 6, the method including connecting at least two leading lines to the structure, wherein the leading lines are spaced apart; and wherein the vector sum of the forces applied to the structure by the at least two leading lines has a direction component acting in the opposite direction to the vector sum of the forces applied by the at least two mooring lines.

11. A method as claimed in claim 10, wherein the mooring line is recovered by a separate support vessel and passed to a towing or trailing vessel for connection to the structure.

12. A method as claimed in claim 1, the method including controlling the descent of the structure to the target installation site by adjusting at least one of the tension and the length of the leading line between the structure and the lead towing vessel.

13. A method as claimed in claim 12, the method including applying sufficient tension to the leading line to maintain a horizontal component of movement of the structure during descent, and maintaining tension in the mooring lines to resist changes in the orientation of the structure during the descent.

14. A method as claimed in claim 12, the method including checking the position, heading, and depth of the structure prior to landing of the structure on the seabed in the target installation site.

15. A method as claimed in claim 12, including adjusting ballast and buoyancy on the structure system and adjusting leading line tension during the descent and final landing of the structure on the seabed in the target installation site.

16. (canceled)

17. (canceled)

18. method as claimed in claim 1, including tethering a buoy to the structure after the structure has been installed on the target installation site, wherein the method includes connecting at least one buoy mooring line between the buoy and an anchor point on the seabed before connecting tethers between the buoy and the structure.

19. A method as claimed in claim 18, including paying out leading line from the lead towing vessel once the buoy is in position above the installed structure, and using the paid-out leading line as an additional mooring line for the buoy.

20. A method as claimed in claim 19, the method including connecting an anchoring device to the end of the paid-out leading line prior to its deployment on the seabed, and laying out the paid-out leading line under tension to minimum slack, the mooring lines connected to the buoy acting together to constrain movement of the buoy relative to the installed structure.

21. A method as claimed in claim 18, including spacing the structure away from the seabed and constraining movement of the structure in the spaced position relative to the seabed by the tensioned mooring lines.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A subsea storage tank assembly having at least one storage compartment for storage of production fluids produced from an offshore subsea oil or gas well, the subsea storage tank assembly comprising at least one item of subsea equipment supported on the storage tank assembly and wherein the subsea equipment comprises a structural support frame adapted to resist movement of the subsea equipment relative to the storage tank assembly.

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)
